(19) United States
(12) Patent Application Publication
(10) Pub. No.: US 2026/0251547 A1
(43) Pub. Date: Aug. 27, 2026

(54) PARTICLE CHARACTERISATION

(71) Applicant: Malvern Panalytical Limited, Worcestershire (GB)

(72) Inventors: Michael J. KNIGHT, Worcestershire (GB); Jason CORBETT, Worcestershire (GB); Alex MALM, Worcestershire (GB); Douglas HAMILTON, Worcestershire (GB); Rhys POOLMAN, Worcestershire (GB); Detlef BECKERS, Worcestershire (GB); Charalampos ZARKADAS, Worcestershire (GB); Adam HALL, Worcestershire (GB); Stephen WARD-SMITH, Worcestershire (GB); Rory BRITTAIN, Worcestershire (GB); Benjamin PATTISON, Worcestershire (GB); Anne VIRDEN, Worcestershire (GB)

(73) Assignee: Malvern Panalytical Limited, Worcestershire (GB)

(21) Appl. No.: 19/160,094

(22) PCT Filed: Feb. 27, 2024
(86) PCT No.: PCT/IB2024/000169

§ 371 Date: Aug. 27, 2025

(30) Foreign Application Priority Data
Feb. 27, 2023 (GB) 2302879.8

(51) Int. Cl. G01N 15/0205; G01N 15/075

(52) U.S. Cl. CPC G01N 15/0211; G01N 15/075

(57) ABSTRACT

A method of investigating time varying sample characteristics is disclosed. The method comprises illuminating a sample comprising particles with a light beam, so as to produce scattered light by the interaction of the light beam with the sample, obtaining a measurement of the scattered light over a measurement period that is divided into a plurality of shorter sub-runs, classifying each sub-run, and determining the sample particle characteristic for the sub-runs. The method may further comprise transforming each sub-run prior to classifying each sub-run. Determining the sample particle characteristic for the sub-runs may occur prior to classifying each sub-run. The method may also comprise determining a variation in the sample particle characteristic over time for the sub-runs.

### FIELD OF INVENTION

The invention relates to a particle characterisation instrument, and to a method of particle characterisation, which may include diffraction analysis.

### BACKGROUND

Laser diffraction is a technique for characterising particles by analysing a pattern of diffracted or scattered light from a sample. It is a ubiquitous technique for the non-invasive characterisation of ensembles of particulate materials, in particular to yield the hard-sphere, particle size distribution (Light Scattering by Small Particles, H. C. van de Hulst, Dover (2003), ISBN-10: 0486642283, ISBN-13: 978-0486642284; Absorption and Scattering of Light, W. V (2012), ISBN-10: 9780471293408, ISBN-13: 978-0471293408).

Laser diffraction analysis is typically performed on a suspension of particles in a dispersant fluid, which may be a liquid or a gas. The pattern of diffracted light can be used to infer a particle size distribution, for example based on Mie scattering theory.

Single-shot, non-recirculating systems are often used in dry measurements since the continuous entrainment of particles in a low density dispersant, such as air, is highly challenging. A dry powder feed may be used to introduce the particles into the dispersant fluid.

It is not uncommon to find laser diffraction measurements included as part of larger systems, in particular in combination with other processes and detection modalities such as in-line with chemical reactors and milling apparatus and via sampling from industrial processes either to waste or as part of a recirculating loop.

Laser diffraction measurements can suffer from causes of measurement uncertainty that typically require expert users to identify and correct. The incorrect identification or incomplete removal of such uncertainties can result in significant but hidden uncertainties (or errors) in the reported results. In some cases, uncertainties in measurements may result in testing until the measurement conforms with expectations, which is not appropriate for a quality assurance/quality control environment (an important application of laser diffraction).

The primary particle size distribution (PSD) determined by diffraction analysis may change over time. Some special causes that may cause this include those that affect the sample itself, such as grinding, agglomeration, dissolving and swelling (Lloyd S. Nelson, “The Shewhart Control Chart—Tests for Special Causes”. Journal of Quality Technology 16, no. 4 (October 1984), 238-39.; Grinding—Bonakdar T., et al, International Journal of Pharmaceutics, Volume 501, Issues 1-2, 30 Mar. 2016, Pages 65-74; Aggregation—Kasmerchak et al, Geoderma, Volume 338, 15 Mar. 2019, Pages 430-444, Dissolving—Azad M. et al, Drug Development and Industrial Pharmacy, 41:10, 1617-1631) and instrumental effects such as particle size dependent build-up of fractions (or parts) of the total PSD on the inner walls of the measurement cell, thereby biasing the remaining sample, entrained within the flow path (Kupetz, M., Backes, L., Ramsauer, B. et al. Eur Food Res Technol (2019)). Careful addition of surfactants, for example, may be used to minimise interparticle and particle-environment interactions, but the identification of such a need from the data has hitherto been based on operator training/expert knowledge or worse, a priori knowledge of what the primary PSD should be, which leaves room for improvement.

Further inconveniences with known techniques may also include:
1) Many commercially available laser diffraction instruments use a standard operating procedure-based measurement structure, that allows the user to setup the measurement conditions, such as the flow-rate in the sample dispersion accessory, the measurement time and the number of measurements, etc. A set of measurement parameters may be developed which form the basis of a standard operating procedure (SOP). This can be a laborious and iterative process and may be based on the experience of the operator with samples of a similar type. This may create significant random and/or systematic uncertainties in the SOP/measurement;
2) The detection of spurious effects, such as grinding, buoyancy, dissolving or agglomeration of the sample, etc. has previously been left to the trained user to sit and watch the measurement as it proceeds;
3) Very low concentrations of particular size fractions that would be characterised by number, rather than in an ensemble sense, may appear rarely, but repeatedly and at random times. They may, therefore, be large enough and concentrated enough to perturb the analysis of the primary particle sample of interest, but with a significant uncertainty in the reported relative abundance; or be abundant enough to perturb the analysis of the particle size distribution of the sample of interest, but rare enough to fall beneath any thresholds that may exist in the analysis; or may simply be averaged out over time and would therefore not be reported to the operator; and
4) The overall measurement time for each aliquot is typically set prior to the measurement, based on operator experience. This may lead to a result that includes systematic as well random uncertainties or possibly even testing to conformance with a stable, but incorrect, particle size distribution reported.

WO2017/051149 discloses methods for particle characterisation comprising correcting for light scattered from larger particles.

Although progress has been made in improving the robustness of particle characterisation from scattered light, considerable room for improvement remains.

### SUMMARY

According to a first embodiment, a method of investigating time varying sample characteristics is disclosed. The method comprises illuminating a sample comprising particles with a light beam, so as to produce scattered light by the interaction of the light beam with the sample, obtaining a measurement of the scattered light over a measurement period that is divided into a plurality of shorter sub-runs, classifying each sub-run, and determining the sample particle characteristic for the sub-runs.

The method may further comprise transforming each sub-run prior to classifying each sub-run. Transforming each sub-run may include performing a dimensionality reduction on each sub-run, in order to make the data more manageable. This may be beneficial, as mathematical reduction of a single segment is more robust than an average across multiple segments. Transforming each sub-run may be performed using a processor. Determining the sample particle characteristic for the sub-runs may occur prior to classifying each sub-run. Once the sub-runs have been classified, the sub-runs may be reconstructed (for example, by Mie inversion by non-negative least squares (NNLS)). Reconstruction may be performed in a using different techniques, dependent upon the classification. The method may also comprise determining a variation in the sample particle characteristic over time for the sub-runs.

A method of investigating time varying sample characteristics is also provided. The method comprises illuminating a sample comprising particles with a light beam, so as to produce scattered light by the interaction of the light beam with the sample;
obtaining a measurement of the scattered light over a measurement period that is divided into a plurality of shorter sub-runs;
classifying each sub-run; and
determining a variation in a dynamic particle characteristic over time, comprising determining the dynamic particle characteristic for the sub-runs in a classification.

It will be appreciated that illuminating a sample with a light beam may, more commonly, be referred to as irradiating a sample with a beam of x-rays, in an x-ray arrangement. Similarly, the light source may refer to a source, such as a laser, or may refer to an X-ray source (such as an X-ray tube), depending on the instrument being utilised. Additionally, the scattered light may be diffracted or scattered X-rays in an x-ray arrangement.

Measurement of the scattered light may be obtained at a plurality of detection angles.

Analysis of a particular classification of sub-runs for changing sample characteristics (i.e. sample properties) enables robust automatic analysis of sample properties that change over time. The classification of sub-runs may enable particular types of measurement data to be grouped (classified), and the time trends in each group (classification) may reveal more about the dynamic properties of the sample than simply trying to look for trends in all the data. For example, in some embodiments, the sample may comprise contaminants that cause measurement error and/or uncertainty in the measurement of a primary fraction of the sample. Each sub-run may be automatically classified as either comprising a contaminant or not comprising a contaminant. Reliable measurements of the time varying properties of the primary fraction may thereby be obtained by analysis of the sub-runs classified as not comprising a contaminant.

In some embodiments, prior to classifying each sub-run, each sub-run may be transformed. In this regard, transformation may include a dimensionality reduction to make the data more manageable.

In some embodiments, the dynamic sample characteristic may comprise particle size and/or particle concentration. In other embodiments, the dynamic particle characteristic may comprise an intensity of scattered light received by at least one detector element.

The method may further comprise determining a particle size distribution and identifying particle fractions for each sub-run in the classification, wherein the particle size is an average particle size for a particle fraction and/or the particle concentration is a concentration of the particle fraction.

Classifying each sub-run may comprise determining a classification particle characteristic and comparing the classification particle characteristic with a threshold value of the same characteristic.

The threshold value may be determined from statistics of the classification particle characteristic in at least some of the sub-runs. Using the statistics of at least some of the sub-runs may enable the classification criteria to be responsive to the sample. This may be advantageous of predetermined classification criteria.

The threshold value may be a predetermined number of standard deviations from an average value of the classification particle characteristic.

The threshold value for classification of a current sub-run may be determined from a cumulative standard deviation of at least some of the sub-runs preceding the current sub-run. Using a cumulative standard deviation may facilitate the application of a dynamic classification criteria (i.e. one which responds to the measurements) that is applied before all the measurements are obtained, based on those sub-runs that have already been obtained.

A control chart of the classification particle characteristic may be used to classify sub-runs. Classifying sub-runs may comprise determining upper and lower control limits, either side of a mean value of the classification particle characteristic (e.g. n standard deviations from the mean, where n may be 2, 3 or some other number or fraction). A set of classification rules may be used to classify sub-runs. The rules may comprise at least one of:
a) a classification particle characteristic being outside the control limits;
b) a run (of consecutive sub-runs) of more than m particle classification characteristics to the same side of the mean;
c) a run of n particle classification characteristics all increasing or decreasing;
d) a run of o particle classification characteristics alternating up and down;
e) a run of p particle classification characteristics more than 2 standard deviations from the mean;
f) a run of q particle classification characteristics more than 1 standard deviation from the mean; and
g) a run of r particle classification characteristics within less than one standard deviation of the mean.

Classifying each sub-run may comprise classifying each sub-run as either transient or non-transient. In some embodiments, a sub-run may be classified as transient if the classification particle characteristic exceeds the threshold value. A further classification of trending may be used for sub-runs that are not transient but in which the particle classification characteristic is drifting, for example based on rules b) and/or c) above.

The method may further (alternatively or additionally) comprise automatically (e.g. with a processor) classifying the variation in the dynamic particle characteristic (e.g. as trending or steady state or another category).

The method may further (alternatively or additionally) comprise automatically correlating a trending state in a first particle fraction with a complementary trending state in a second particle fraction.

The dynamic particle characteristic and/or the classification particle characteristic may be determined from a diffraction analysis or a dynamic light scattering analysis.

The method may further (alternatively or additionally) comprise classifying the variation in the dynamic particle characteristic.

In some embodiments, classifying the variation in the dynamic particle characteristic may comprise identifying the variation as attributable to aggregation or coalescence when there are sub-runs classified as transient and the variation in the dynamic particle characteristic for the non-transient sub-runs is classified as trending.

The variation may be identified as attributable to coalescence when the variation in the dynamic particle characteristic for the transient sub-runs is classified as trending. The variation may be identified as attributable to aggregation when the variation in the dynamic particle characteristic for the transient sub-runs is not classified as trending. In this regard, it may be possible to distinguish between coalescence and aggregation by testing the data against a model of coalescence or aggregation, or by using a machine learning algorithm.

The term sample fraction (or particle fraction) may refer to all of the sample (or all of the particles), where there is a single sample (particle) fraction.

In some embodiments, classifying the variation in the dynamic particle characteristic may comprise identifying the variation as attributable to particle milling where there are sub-runs classified as trending, and the variation in the dynamic particle characteristic indicates that a mean particle size of particles is decreasing and the total mass of the particles in the sample is not decreasing.

In some embodiments, classifying the variation in the dynamic particle characteristic may comprise identifying the variation as attributable to particle dissolution where there are sub-runs classified as trending, and the variation in the dynamic particle characteristic indicates that a mean particle size of particles is decreasing and the total mass of the particles in the sample is decreasing.

According to a second aspect, there is provided a non-transient, machine readable medium, comprising instructions for configuring an apparatus comprising a processor to perform the method of the first aspect.

According to a third aspect, there is provided an apparatus for investigating time varying sample characteristics, comprising:
a light source, a sample holder, a detector and a processor; wherein the sample holder is configured to receive a sample comprising particles; the light source is operable to illuminate the sample holder with a light beam so as to produce scattered light by interactions of the light beam with the particles of the sample;
the detector is configured to detect the scattered light over a measurement period;
the processor is configured to:
   divide the measurement period into a plurality of shorter sub-runs;
   classify each sub-run; and
   determine a variation in a dynamic particle characteristic over time, comprising determining the dynamic particle characteristic for the sub-runs in a classification.

The apparatus may be configured to perform a diffraction analysis. The apparatus may comprise a plurality of detectors arranged to detect light scattered at a plurality of different scattering angles to the light beam incident on the sample.

The apparatus may be configured to perform a dynamic light scattering analysis.

The apparatus may be configured to perform the method according to the first aspect, including any of the optional features thereof.

### BRIEF DESCRIPTION OF DRAWINGS

Embodiments of the invention will now be described, by way of example only, with reference to the following drawings, in which:

FIG. 1 is a schematic of a measurement arrangement for a light scattering particle characterisation apparatus;

FIG. 2 is a schematic of an x-ray diffraction apparatus;

FIG. 3 is a schematic representation of a particle characterisation apparatus according to an embodiment;

FIG. 4 is a schematic representation of a particle characterisation apparatus processing means according to an embodiment;

FIG. 5 is a flow diagram of a method according to an embodiment;

FIG. 6 shows a cumulative standard deviation plot of Dv10 and Dv90 for seventy sub-runs of a laser diffraction measurement;

FIG. 7 shows an X-bar chart of Dv10 for seventy sub-runs of a laser diffraction measurement;

FIG. 8 shows an X-bar chart of Dv90 for seventy sub-runs of a laser diffraction measurement;

FIG. 9 shows a sequence of scattered light intensities measured at different detectors, in which transient scattering events contribute to the scattered light;

FIG. 10 shows the reporting of both the summed transient and summed steady state data and associated reduced particle size distributions of a laser diffraction measurement;

FIG. 11 shows a plot of the cumulative mean of Dv50 for seventy sub-runs of a laser diffraction measurement;

FIG. 12 shows an X-bar chart of Dv50 for seventy sub-runs of a laser diffraction measurement;

FIG. 13 shows a schematic plot of particle size distribution for a plurality of sub-runs of a laser diffraction measurement exemplifying both non-transient and transient sub-runs;

FIG. 14 shows a schematic plot of particle size distribution for a plurality of sub-runs of a laser diffraction measurement exemplifying both non-transient and transient sub-runs;

FIG. 15 shows a schematic plot of particle size distribution for a plurality of sub-runs of a laser diffraction measurement exemplifying both non-transient and transient sub-runs, indicative of a coalescing sample;

FIG. 16 shows a schematic plot of particle size distribution for a plurality of sub-runs of a laser diffraction measurement exemplifying both non-transient and transient sub-runs, indicative of a sample experiencing Ostwald ripening;

FIG. 17 shows a schematic plot of particle size distribution for a plurality of sub-runs of a laser diffraction measurement exemplifying both non-transient and transient sub-runs, indicative of aggregation or flocculation;

FIG. 18 shows the cumulative mean and the cumulative standard deviation of Dv50 of a 1.0 μm latex dispersed in DI water across seventy sub-runs;

FIG. 19 shows a schematic plot of particle size distribution for a plurality of sub-runs of a laser diffraction measurement exemplifying non-transient sub-runs;

FIG. 20 shows groups of particle size distribution for a plurality of sub-runs of a laser diffraction measurement exemplifying transient particle fractions;

FIG. 21 shows a schematic representation of adaptive measurement settings for a laser diffraction measurement based on feedback from an instrument used to carry out the measurement;

FIG. 22 shows a schematic multidimensional pictogram representation of particle size distribution for a plurality of sub-runs of a laser diffraction measurement exemplifying transient and non-transient sub-runs;

FIG. 23 shows a schematic heat-map representation of particle size distribution for a plurality of sub-runs of a laser diffraction measurement exemplifying transient and non-transient sub-runs;

FIG. 24A shows measurement data for a multi-particle sample, with FIG. 24B (a reconstruction of data from a single particle, from the boxed area ‘B’ in FIGS. 24A) and 24C (a reconstruction of data from the boxed area ‘C’ in FIG. 24A) being a sub-set of the FIG. 24A results;

FIGS. 25A-25D show scattering data for a series of aliquot concentration reductions;

FIGS. 26A and 26B show exemplary scattering data for very low sample quantities;

FIGS. 27A-27C show exemplary scattering data for low sample quantities;

FIGS. 28A and 28B show alternative analysis techniques for single-particle analysis;

FIG. 29 shows an alternative analysis technique for single-particle analysis;

FIGS. 30A and 30B show analysis techniques for determining particle photometric mass and total sample photometric mass, respectively; and

FIG. 31 shows a schematic identifying a local background estimate around each particle event.

### DETAILED DESCRIPTION

FIG. 1 shows a schematic of a light scattering particle characterisation instrument 10, whereby a light beam 11 (e.g. from a laser) is directed through a sample holder 12 that holds a sample comprising particles 14 suspended in a diluent (may also be referred to herein as a dispersant) 15. In this embodiment the sample holder 12 is a flow cell, through which the sample comprising particles 14 passes. In other embodiments, the sample holder may be a surface on which a sample droplet is supported, a capillary, flow cell or a cuvette. Scattered light 13 from the interaction of the illuminating laser 11 with the particles 14 forms a far-field diffraction pattern, which is detected by detectors (not shown) arranged to receive light scattered at different angles to the light beam 11. A vector of the intensity of scattered light at different scattering angles may be inverted (e.g. based on Mie scattering theory) to determine a particle size distribution. Also shown in FIG. 1 is an optical flow cell front window 16 and optical flow cell rear window 17 (although those skilled in the art will appreciate that depending on the arrangement, these may not be as depicted, or even necessary).

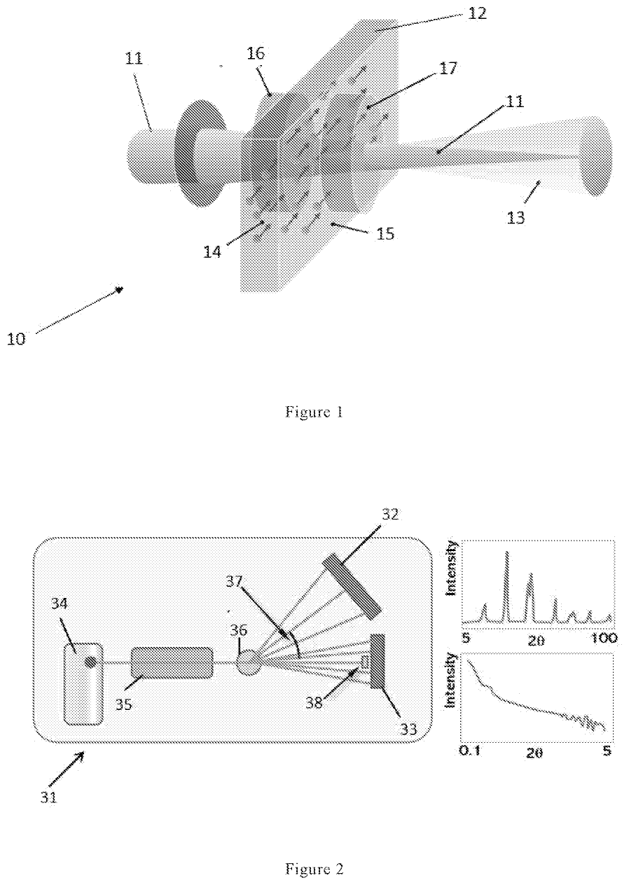

Another technique for characterising particles is x-ray diffraction (XRD). FIG. 2 shows a schematic illustration of an x-ray diffraction instrument 31 with a light source 34 (i.e. an x-ray source), collimator 35, sample 36 and wide and small angle x-ray scattering detectors 32, 33. The light beam from x-ray source 34 is collimated into an illuminating beam by collimator 35. The illuminating beam is directed through the sample 36, and light (in the form of x-rays) is scattered by particles of the sample 36 (e.g. from atoms in a crystal lattice). The diffraction pattern from the particles of the sample 36 may be used to infer characteristics of the sample and their arrangement in the sample. Scattering angle 2θ 37 and beam stop 38 are also shown in FIG. 2.

Typical sources of XRD uncertainties and their mitigation in accordance with certain embodiments are discussed below.

In on-line XRD or small-angle x-ray scattering (SAXS), a continuous stream of powders, slurries or liquids is analysed. This sample stream might be inhomogeneous over time. Data collection is often performed by fast scans that are summed up over a certain time period to a resulting scan or, when a static detector is used, the recorded data is typically the sum of many recorded detector frames (data snap shots) over a certain time period. Averaging the data over a long time period may mask effects of phase changes or sample composition variations especially if the variation is occurring on minority phases.

Particularly for static detectors these data frames can be collected in quite short sub-runs (in the milli-second range). Classification of each sub-run enables grouping of the data into different relative compositions. Subsequent diffraction analysis may be performed on each classification of sub-run (e.g. by combining the data from sub-runs in a particular classification, or by combining the result of analysis of each sub-run in a classification). Performing separate analysis on each classification can improve the analysis, especially on minority phases. Separate analysis of diffractograms with a relatively high concentration of the minority phase (i.e. with (relatively) low concentration of the majority phases) may improve detection limits or improve the structural analysis of the minority phase. This approach may also improve the sensitivity for small relative structural changes of the minority phase. Outlier analysis may also be improved, since the data from outliers may be classified as such and separated from the main data stream. The same approach is possible in the analysis of SAXS data of a sample stream that is changing in time. One such example would be a protein sample flow of varying oligomeric state. By classifying the collected sub-runs (e.g. data frames) based on their similarity, good SAXS patterns of the pure phases may be achieved instead of only a mixed/averaged SAXS pattern (e.g. SAXS patterns nearer to those of pure oligomers could be obtained instead of only the mixed state).

Randomly occurring environmental events can also influence the quality of an X-ray measurement. For experiments with weak sample scatter, a good signal-to-noise ratio is crucial for good measurement results and accurate sample analysis. Examples for these types of applications include grazing-incidence small-angle x-ray scattering (GI-SAXS) or SAXS measurements that require long data collection times for sufficiently good counting statistics in the data. Low air scatter and low noise of the detection system are important. However, in practice, the achievable noise level and data quality is determined by disturbing signals from the environment (like e.g. cosmic rays) that are also detected and which do not originate from the sample. These signal events typically appear randomly and are overlapping with the scattered X-ray signal from the sample.

By classifying sub-runs (e.g. data frames/data snap shots) from the detector into those that do contain disturbing environmental signals and those that do not contain disturbing environmental signals, the data quality of the measurement from the sample can be significantly improved (i.e. improved noise level). It will also be appreciated that a separate analysis of disturbed data frames is also possible.

Repeatedly fast changing samples (e.g. samples in fast cycling in-situ reactions, charging/discharging batteries, a biological sample stream that undergoes radiation damage) typically show a repeating time changing data pattern in X-ray measurements. The data quality of a short measurement might not be good enough for accurate analysis and averaging the data collection over a longer time may hide important sample properties or sample reaction effects. Classification of the data from sub-runs (e.g. fast snap shots/data collection frames) arising from similar sample conditions or sample states may enable improved quality of analysis of the different sample states and sample conditions.

To the extent that prior art methods consider the problem of contaminants, data that includes scattering from contaminants is typically discarded or included in averaging of the data collection. The consequence of this crude approach is that data may be wrongly discarded or it may skew the average of the data collection, and as a consequence incomplete or unrepresentative results may be presented, or longer run times may be necessary to obtain sufficient valid data.

Many of these uncertainties are time resolved such as the presence of spurious size fractions, i.e. particles which are significantly bigger or much smaller than the majority of the particles in a sample, or trending or bias in the measured particle size distribution, all of which may be partially averaged out using an arbitrary measurement length. In addition, embodiments may enable more accurate characterisation of small numbers of spurious size fractions in the presence of the primary ensemble (i.e. samples representative of the majority of the particles in the sample).

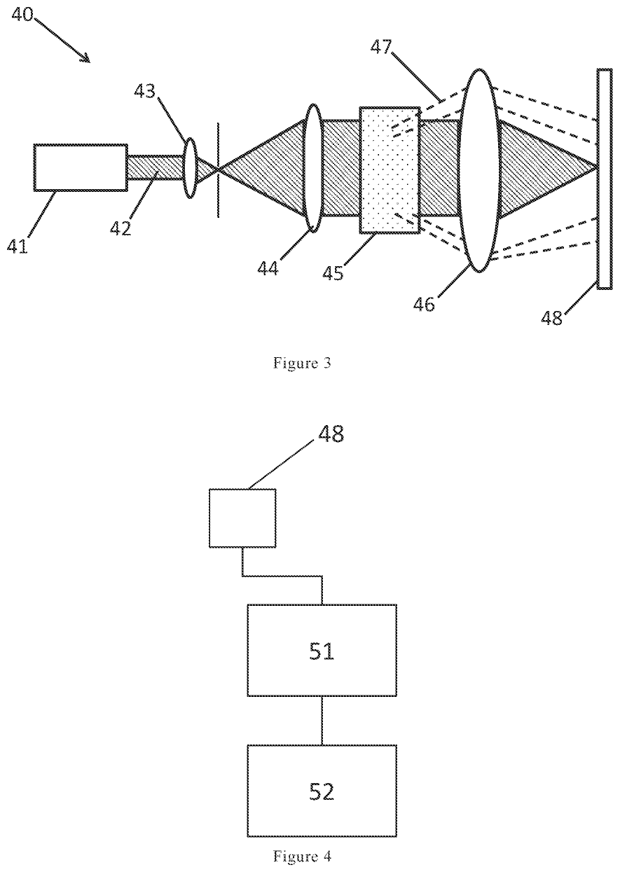

FIG. 3 shows a schematic representation of a particle characterisation apparatus 40. The apparatus 40 comprises a light source 41, first, second and third optical elements 43, 44, 46, sample holder 45 and detector 48.

The light source 41 may be a laser source. In an alternative embodiment, the light source 41 may be an x-ray source. The light source 41 projects a light beam 42 through the sample holder 45, which contains a sample comprising particles. The first and second optical elements 43, 44 are configured to form the light beam 42 into a suitable configuration within the sample (in this example, into a collimated beam). Other arrangements of optical elements may be used, and this arrangement is merely an illustrative example. The light beam 42 is represented schematically by the hatched areas in FIG. 3. A portion of the light beam 42 is diffracted by the particles in the sample to form diffracted light 47. The diffracted light 47 is focussed by the third optical element 46 at the detector array 48. The detector array 48 detects a scattering pattern produced by the diffracted light 47. In other embodiments, the detector may not be in the form of an array, and separate discrete detector elements positioned at different locations may be used to obtain a vector of scattering intensities at different scattering angles. In some embodiments the detector may comprise a combination of an array of detector elements and at least one discrete detector element.

A further alternative method of determining particle characteristics (e.g. size, zeta potential etc.) is dynamic light scattering (DLS), also known as photon correlation spectroscopy. In DLS, a time series of measurements from one or more detectors may be used to determine particle characteristics, based on the way the scattering signal changes over time. Low frequency changes in the scattering intensity may be attributed to large particles, and high frequency changes attributed to smaller particles. A high speed, sensitive detector (such as an avalanche photodiode) is typically used in such an instrument, which detects a relatively narrow range of scattering angles centred on the detection angle (e.g. a range of 5 degrees or less, or 2 degrees or less). The time history of scattering intensity from the at least one detector may be inverted by correlating the scattering intensity, thereby determining at least one autocorrelation function. A fit may be performed to the autocorrelation function (e.g. CONTIN, or any other method) to determine a particle size (e.g. a Z_{average} particle size), or a particle size distribution.

FIG. 4 shows a schematic representation depicting the detector 48, a processor 51 and an output device 52. For a diffraction based instrument, the detector 48 will typically comprise a plurality of detectors, such as the detector array 48 described in relation to FIG. 3, arranged to detect light scattered at a plurality of different scattering angles to the light beam 42 incident in the sample. For a DLS instrument, there may be a single detector that detects light scattered at a detection angle, a single detector and a reconfigurable collection optic that can be controlled to direct light from different detection angles to the detector, or multiple detectors at different detection angles. The processor 51 receives a series of measurements of light intensity at the or each detector, produced by the diffracted light 47 from the detector array 48. In the case of a dynamic light scattering measurement, the processor 51 may be configured to perform a correlation operation on the measurements to characterise particles of the sample.

The processor 51 may store the measurements in a machine readable storage medium, for example in memory, on a solid state storage drive, a hard disk, in the cloud, etc. The processor 51 may then output the results of the analysis to the output device 52, which may comprise a display screen.

The processor 51 is further configured to divide the measurements into a plurality of shorter sub-runs, classify each sub-run, and determine a variation in a dynamic particle characteristic over time by determining the dynamic particle characteristic for the sub-runs in a classification.

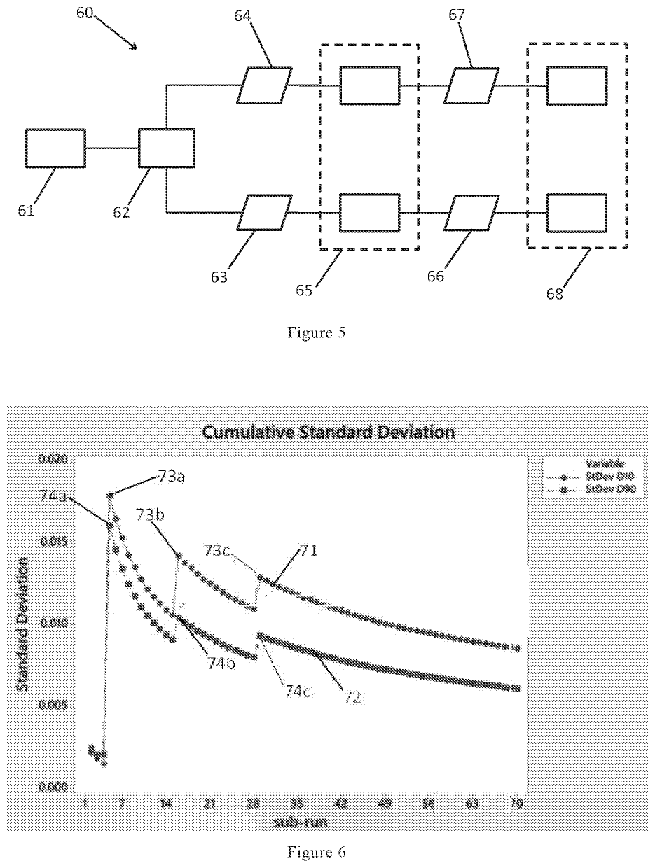

FIG. 5 shows a flow chart/diagram illustrating a method 60 according to an embodiment. The method begins at step 61 by obtaining measurements of scattered light, for example using the apparatus 40 of FIG. 3. The measurements are divided into a plurality of sub-runs, either during the measurement (e.g. by acquiring a sequence of sub-runs) or after the measurement (e.g. by dividing a time series of measured data into sub-runs). At step 62, the method classifies each of the sub-runs. The classification of each sub-run may be based on a classification particle characteristic that is obtained from the sub-run. For example, the classification characteristic may be an average particle size (such as Dv50 or Z_{average}) obtained from diffraction analysis, or by a dynamic light scattering analysis. In other embodiments, the classification may be based on an environmental condition, such as sample temperature or pH, with different sub-runs classified. The classification of the sub-runs may be performed automatically, based on pre-determined criteria that are set by a user.

In the example of FIG. 5, each sub-run is classified as either transient 63 or non-transient 64. The transient category/classification means that the sub-run is significantly different from the other sub-runs in the measurement (either so far, or in total). The non-transient category/classification means that the sub-run is similar to the other sub-runs in the measurement (either so far, or in total). Where classification is based on e.g. average particle size, a threshold based on the statistics of the sub-runs may be used as a threshold for classification. For example, an average particle size that is more than three standard deviations away from the mean average particle size over the other sub-runs may be used to classify a sub-run as transient.

It is not essential that all the sub-runs are classified. In some embodiments a single classification may be used, for example to select measurements with low noise, discarding the others. It is likewise not essential that particle size is used for classification, and other parameters may be used (such as polydispersity index, scattering intensity etc.). In another examples, the method may classify some or each of the sub-runs as one of three or more classifications.

Again referring to the example of FIG. 5, once each of the sub-runs has been classified as either transient 63 or non-transient 64, at step 65, a variation in a dynamic particle characteristic is obtained by determining the dynamic particle characteristic 66, 67 for the sub-runs in one or more of the classifications 63, 64. The variation may indicate that the dynamic particle characteristic is stable (i.e. no variation may be reported).

For example, the non-transient sub-runs may be analysed, and the variation in a dynamic particle characteristic determined for each non-transient sub-run. In one example, the dynamic particle characteristic (i.e. the characteristic that is to be investigated for changes over time) may be an average particle size. Since the non-transient sub-runs exclude the transient scattering which may arise from contaminants, the average particle size over the non-transient sub-runs will be more reliable, enabling more accurate determination of whether there are trends in particle size over the duration of the measurement. The same is true for many other particle characteristics, which may be skewed and/or made unreliable by special causes (e.g. such as those already discussed).

The transient sub-runs may also be analysed to determine a variation in a dynamic particle characteristic. For example, the transient sub-runs may be due to aggregates, which may increase in size during the measurement time. A change in size of the aggregates over the measurement may be used to obtain insight into the sample as a whole.

In this example, at step 68, the dynamic particle characteristic 66, 67 for the sub-runs in each classification 63, 64 is classified as trending or steady state. This is not essential to the invention, but may enable further useful insight to be obtained on the sample. The dynamic particle characteristic may, for example, comprise the median particle size for a particle size fraction of a particle size distribution or PSD (e.g. an intensity weighted PSD).

FIGS. 6 to 9 demonstrate examples of classifying sub-runs. In these examples, classification comprises determining a classification particle characteristic and comparing the classification particle characteristic with a threshold value of the same characteristic. A sub-run is classified as transient if the classification particle characteristic exceeds the threshold value, and non-transient if the threshold value is not exceeded.

Although derived particle diameter characteristics, such as Dv10 and Dv90, are used as classification particle characteristics in the embodiments of FIGS. 6 to 9, it will be appreciated that any suitable derived particle characteristic, including surface area, volume etc., may be used in alternative embodiments to classify the sub-run as transient.

FIG. 6 shows a graph of cumulative standard deviation of Dv10, shown by plot 71, and cumulative standard deviation of Dv90, shown by plot 72, for seventy sub-runs. In the example of FIG. 6, a sub-run is classified as transient if the difference between the cumulative standard deviation of the sub-run and the cumulative standard deviation of the immediately preceding sub-rub exceeds a predetermined threshold. Three sub-runs have been classified as transient. The cumulative standard deviation of Dv10 of these sub-runs are indicated as 73a-c in plot 71, and the cumulative standard deviation of Dv90 of these sub-runs are indicated as 74a-c in plot 72.

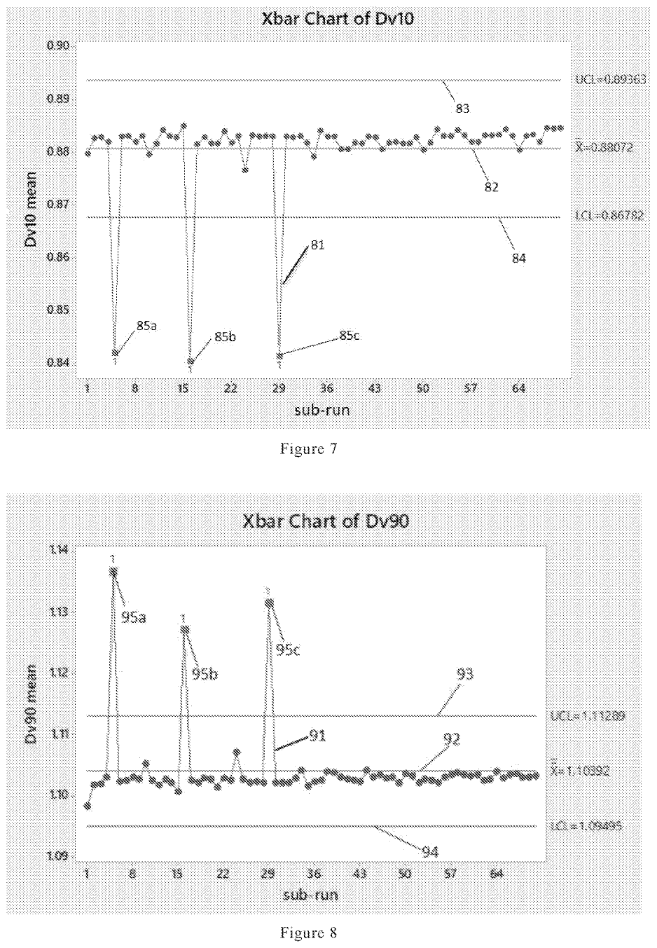

FIG. 7 shows an X-bar chart of Dv10, shown by plot 81. In the embodiment of FIG. 7, the classification particle characteristic is Dv10. The threshold for classification using Dv10 is determined with reference to the mean 82 of Dv10 across all of the sub-runs. A sub-run is classified as transient if the absolute difference between Dv10 of the sub-run and the mean 82 is greater than three standard deviations (indicated by upper and lower limits 83, 84). In FIG. 7, three sub-runs have been classified as transient. The Dv10 of these sub-runs are indicated as 85a-c in plot 81.

FIG. 8 shows an X-bar chart of Dv90, shown by plot 91. The classification particle characteristic in this example is Dv90. The threshold for classification is determined with reference to the mean 92 of Dv90 across all of the sub-runs. A sub-run is classified as transient if the difference between Dv90 of the sub-run and the mean 92 is greater than three standard deviations (indicated by upper and lower limits 93, 94). In FIG. 8, three sub-runs have been classified as transient. The Dv90 of these sub-runs are indicated as 95a-c in plot 91.

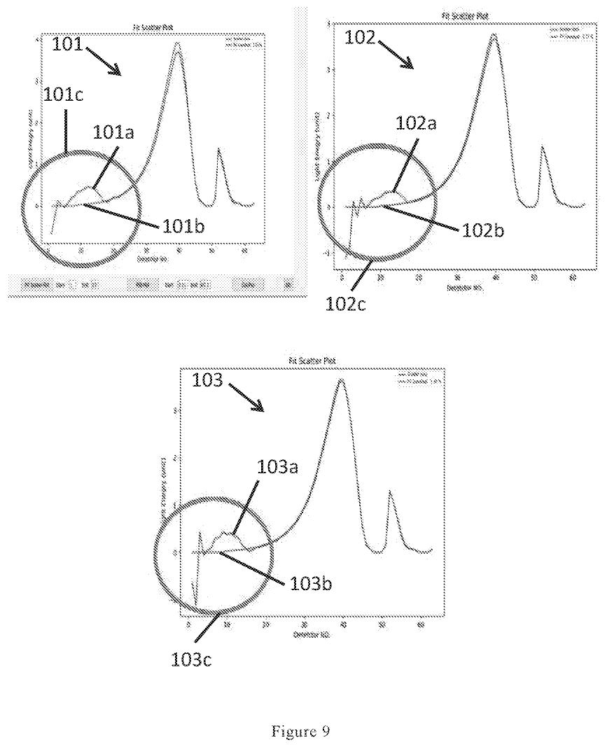

FIG. 9 shows three graphs 101, 102, 103 of scattering intensity measured by each of a plurality of detectors, plotted against detector number. Each detector may be configured to detect light at a different scattering angle (i.e. the range of scattering angles received at each detector may be different). Each of the graphs 101, 102, 103 comprises a plot of a scattering distribution 101a, 102a, 103a and a line of fit 101b, 102b, 103b. As shown by the areas of the graphs indicated as 101c, 102c, 103c, the data on the lower detector numbers (from detector 1 to around 20) has a large relative error (e.g. an average RMS of over 5%) in comparison to the line of fit). This may also be used to determine significant statistical outliers and subsequent classification of sub-runs as transient.

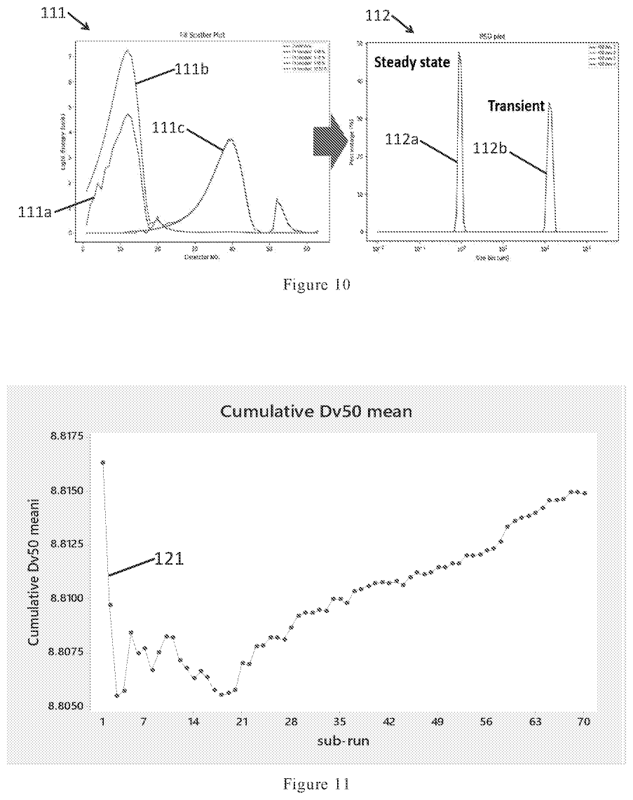

FIG. 10 shows a graph 111 of light intensity plotted against detector number. Graph 111 shows two plots 111a, 111b representing sub-runs that have been categorised as transient and a plot 111c representing sub-runs that have been categorised as non-transient.

FIG. 10 also shows a graph 112 which is a particle size distribution for the categorised sub-runs. Plot 112a of graph 112 shows a particle size distribution for the non-transient sub-runs, and plot 112b shows a particle size distribution for the transient sub-runs. In FIG. 10, the time-averaged transient and time-averaged non-transient data, from a particular sample, are presented independently of each other once classified. This is a particularly useful presentation of data that contain both transient and non-transient classes partially time resolved, for example data that are transient in time but are stable in particle size distribution.

Referring back to FIG. 5, once the dynamic particle characteristic 66, 67 for the sub-runs in each classification 63, 64 has been determined, the dynamic particle characteristic 66, 67 (for example an average particle size, or a median particle size for a particular sample fraction) may be classified as trending or steady state. FIGS. 11 to 17 demonstrate various ways of carrying out and using this classification.

FIG. 11 shows a plot 121 of the cumulative mean of Dv50 (average mass of the distribution) of particles of a sample calculated over seventy sub-runs. There is an upward trend of the cumulative mean of Dv50 from the 20^{th} sub-run onwards. This trend may be used to identify the occurrence of swelling, aggregating, agglomerating, coalescing, instrument instability, etc.

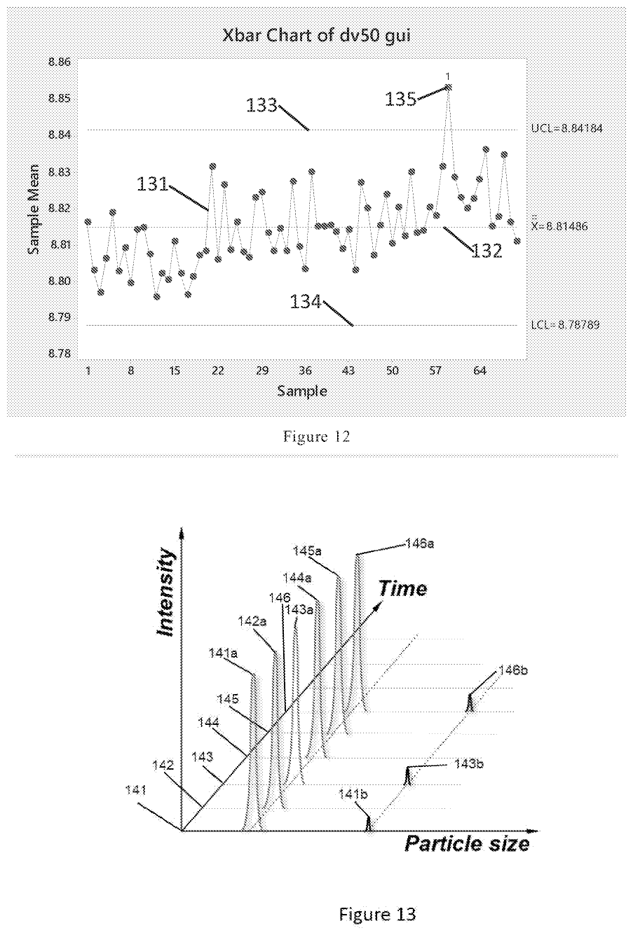

FIG. 12 shows a plot 131 of Dv50, using the same data as in FIG. 11, plotted on an X-bar chart. Shown on the X-bar chart is the mean 132 of Dv50, an upper control limit 133 and a lower control limit 134. Sub-run 58 is classified as transient, the Dv50 of which is indicated at 135, as it falls outside the upper control limit.

The methods disclosed herein may be used to analyse a sample that is flowing to waste, or to monitor a continuous process. Such processes include sample ultrasonication and/or stirring in an instrument dispersion accessory, external grinding and milling (in facilities of all scales from laboratory to industrial), reactions or other particle growth processes, aggregation as part of thermal, chemical or admixture titrations, etc.

The combination of FIGS. 11 and 12 shows that Dv50 is increasing in size over time, indicating that the sample may be swelling or aggregating, in addition to the presence of a transient sub-run at sub-run 58. Transient sub-run 58 may be attributable to a spurious result or a very low concentration (or number) of a particular size class of particles, that may, in fact, be a target size class of interest.

In FIG. 13, a particle size distribution has been determined for each of six sub-runs 141-146. It should be appreciated that additional sub-runs may be utilised in practice, and the representation of six sub-runs is purely to simplify the exemplary embodiment described and facilitate understanding of the concepts disclosed herein. Sub-runs 141, 143 and 146 are shown having two discrete particle size distributions 141a, 141b, 143a, 143b, 146a, 146b, whereas sub-runs 142, 144 and 145 are shown having a single particle size distribution 142a, 144a and 145a. In traditional time-averaged measurements, secondary particle size distributions, such as those depicted by 141b, 143b, 146b, may have been averaged out, resulting in a skew of the overall particle size distribution, and an inability to identify evolution in separate populations within the sample.

Particle size distributions 141a, 142a, 143a, 144a, 145a and 146a are consistent in both particle size distribution and intensity. Particle size distributions 141b, 143b, 146b are also consistent in both particle size distribution and intensity, albeit a larger particle size distribution and lower intensity than particle size distributions 141a-146a. From this, two particle fractions have been identified; a first particle fraction corresponding to the non-transient portions of sub-runs 141-146 (i.e. non-transient particle fractions, 141a-146a) and a second particle fraction (i.e. a transient particle fraction) corresponding to the transient portions of the sub-runs 141a, 143b, 146b. In this regard, FIG. 13 shows a schematic representation of the particle size distribution of each of the non-transient and transient particle fractions for each sub-run. Considering particle size (represented by the horizontal axis) as a dynamic particle characteristic, FIG. 13 shows that the dynamic particle characteristic can be classified as steady-state for both of the non-transient and transient particle fractions. In other words, for both non-transient and transient particle fractions, particle size does not vary over time. This also true when considering particle concentration (represented by the vertical axis) as a dynamic particle characteristic. Such a scenario, where the particle size and concentration does not vary over time for both the transient and non-transient particle fractions may indicate that the sample is not changing over time.

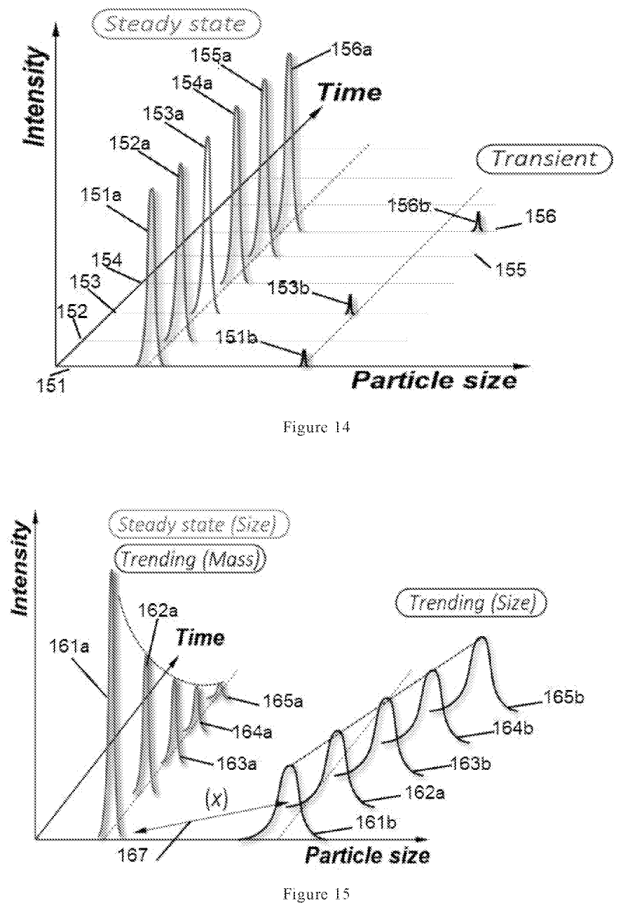

Referring now to FIG. 14, a particle size distribution has been determined for each of six sub-runs 151-156. Sub-runs 151, 153 and 156 are shown having two discrete particle size distributions 151a, 151b, 153a, 153b, 156a, 156b, whereas sub-runs 152, 154 and 155 are shown having a single particle size distribution 152a, 154a and 155a. In this regard, each of the sub-runs 151-156 is shown having at least a portion of the particle size distribution 151a-156a which is consistent in both particle size distribution and intensity. Sub-runs 151, 153 and 156 are shown having a secondary distribution of larger particles 151b, 153b, 156b, identified in each respective sub-run. FIG. 14 shows the particle fractions that are classified in the same way as those in FIG. 13; however in this case the transient events 151b, 153b and 156b have different particle sizes to one another, indicating a more variable sample.

In some embodiments, particle characteristic (e.g. such as the type of information represented by FIGS. 13 and 14) is reported in a time resolved manner. This may be used in any of the following applications:
i. the detection of spurious, specific, size and shape fractions in complex environmental and medical samples and industrial processes, etc.;
ii. improved foodstuffs or personal care products, where a gritty experience in the mouth or on the skin is unpleasant;
iii. improved pharmaceutical development, where large particles are known to illicit an immune response that mitigates the performance of the active ingredient;
iv. improved additive manufacturing of, particularly, structural elements where large particulate inclusions can significantly weaken the structure;
v. pneumatic tyre manufacture where, likewise, small numbers of large particulate inclusions can seriously affect the stability of the tyre;
vi. the milling of cement, calcium carbonate, silica, titania, etc.;
vii. chemical mechanical planarization (CMP) slurries, where the presence of large transients can damage the wafers, which may be expensive, time consuming to replace, and may also require process down-time;
viii. inks and toners, where large particles must be avoided to avoid damaging the transfer mechanism (laser, inkjet, etc.) and the transfer of gritty material to the page. It should be appreciated that while a number of specific applications have been identified, above, the identification of such applications should in no way be considered as limiting the intended scope of applications for which such embodiments may be implemented.

In FIG. 15, a particle size distribution has been determined for each of five sub-runs 161-165. The particle size distribution shown at 161a-165a has been determined for each of five sub-runs which have been classified as non-transient, and a particle size distribution 161b-165b has been determined for each of five sub-runs which have been classified as transient. As described above with reference to FIG. 13, a non-transient particle fraction and a transient particle fraction is identified from the particle size distributions 161a-165a, 161b-165b. As shown in FIG. 15, the non-transient particle fraction is steady-state with respect to particle size and trending with respect to particle mass, and the transient particle fraction is steady-state with respect to particle concentration and trending with respect to particle size. This variation in the dynamic particle characteristics of particle size and particle concentration within each of the non-transient and transient particle fractions may be used to determine that the transient particle fraction is coalescing. This may be further indicated if the difference in particle size between the two fractions, indicated by double-headed arrow 167, is considered small.

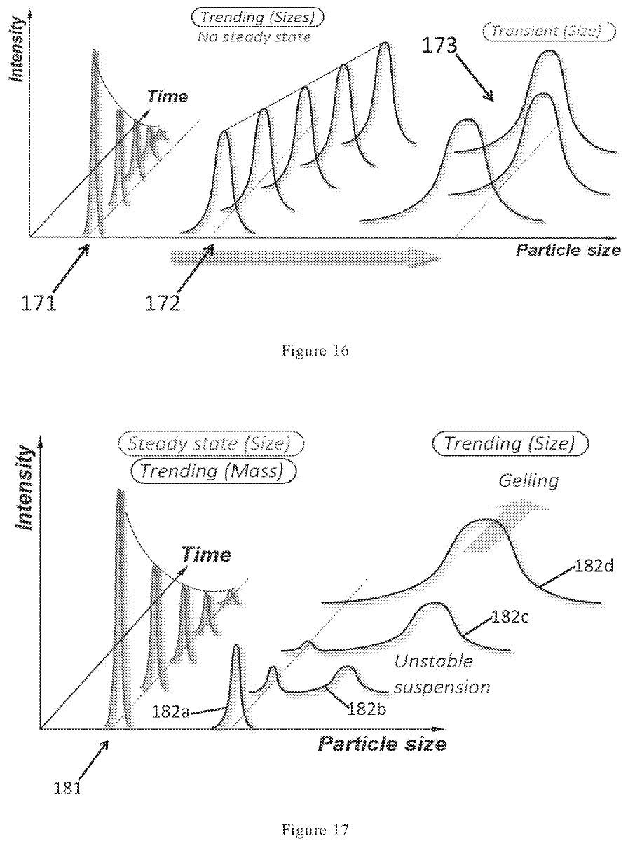

In FIG. 16, three particle fractions 171, 172, 173 have been identified. FIG. 16 shows that the first particle fraction 171 is trending with respect to particle size and trending with respect to particle concentration, the second particle fraction 172 is steady-state with respect to particle concentration and trending with respect to particle size, and the third particle fraction 173 is steady-state with respect to particle concentration and unstable with respect to particle size. This may be indicative of Ostwald ripening within the sample. Ostwald ripening is a form of coalescing, and is the process of dissolution of small sols and their deposition onto larger sols, as they are energetically favoured with a larger volume to surface ratio, where particles are less stable as part of a particle boundary as they are surrounded in the volume of a crystal lattice, for example.

In FIG. 17, a non-transient particle fraction 181 has been identified which is steady-state with respect to particle size and trending with respect to particle concentration. A transient particle fraction 182 has also been identified which is unstable with respect to both particle size and particle concentration, as shown by plots 182a-d. This may be indicative of aggregation within the sample, with the transient particle fraction experiencing gelling. In cases where the sample is exposed to an external stimulus, such as an admixture or alteration of the chemistry of the sample, this may be indicative of flocculation. These processes may occur over a longer timescale than that over which measurement is obtained. However, the kinetics of the sample as the measurement is obtained may be investigated using an appropriate classification of the sub-run data.

The techniques disclosed herein may be applicable to any diffraction based instrument. Methods disclosed herein may be used for nanoscale characterisation, for instance to investigate protein unfolding kinetics (e.g. under external stress such as thermal aggregation kinetics), and chemically induced aggregation (e.g. resulting from variation in pH and/or ionic conditions).

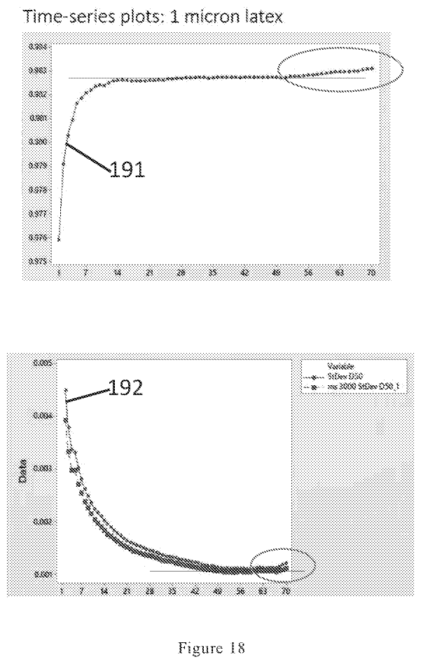

Time resolved reporting (using sub-runs) may be used to determine when obtaining the measurement can be stopped. FIG. 18 shows the cumulative mean (plot 191) and the cumulative standard deviation (plot 192) of Dv50 of a 1.0 μm latex dispersed in deionised (DI) water across seventy sub-runs. As can be seen in FIG. 18, the asymptotic behaviour of the cumulative mean and the cumulative standard deviation indicates that obtaining the time series of measurements could have stopped after approximately twenty sub-runs or so for a mean value and fifty sub-runs for the standard deviation. However, both start to trend more slowly again at around fifty sub-runs for the mean and around sixty-five sub-runs for the standard deviation, possibly due to instrument drift or perturbation of the sample by a dispersion process. This process is not limited to a single derived particle characteristic and also not only from the non-transient sub-runs.

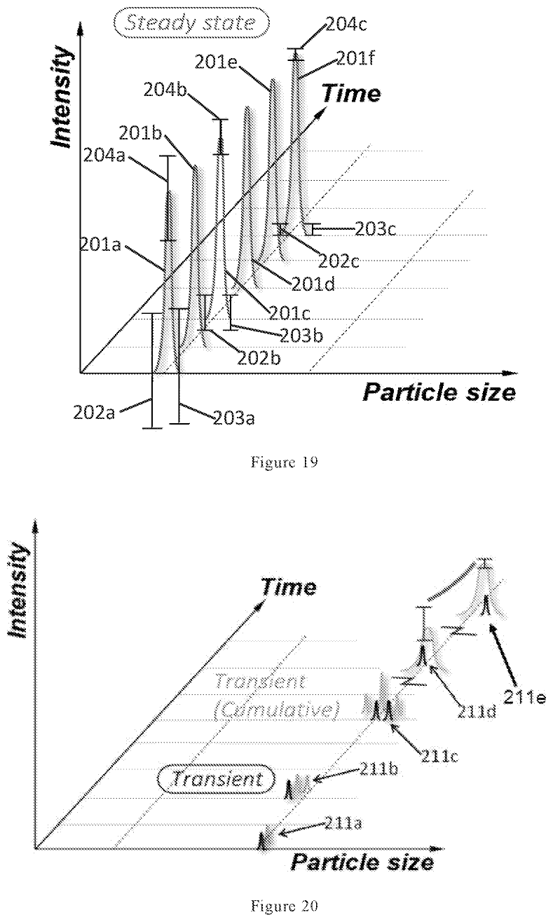

In FIG. 19, a particle size distribution 201a-f has been determined for each of six sub-runs which have been classified as non-transient. Error bars 202a-c, 203a-c, 204a-c represent the error of Dv10, Dv50 and Dv90, respectively, of the sub-runs 201a, 201c and 201f. FIG. 20 shows that these error bars are steadily reducing as the time series of measurements is obtained.

In FIG. 20, groups of particle size distributions 211a-e have been determined for each of five sub-runs which have been classified as transient. The time series of measurements obtained to provide the sub-runs have been taken over a relatively long period of time from laser diffraction measurements at an extremely low sample concentration. If instrumental drift can be avoided or characterised, then a representative sample analysis may be built up over time for samples that are stationary and ergodic but of so low concentration that they become transient once dispersed.

FIGS. 19 and 20 show that the point at which obtaining the time series of measurements can be stopped can be determined on a sound statistical basis based on time reported data from the time series of measurements.

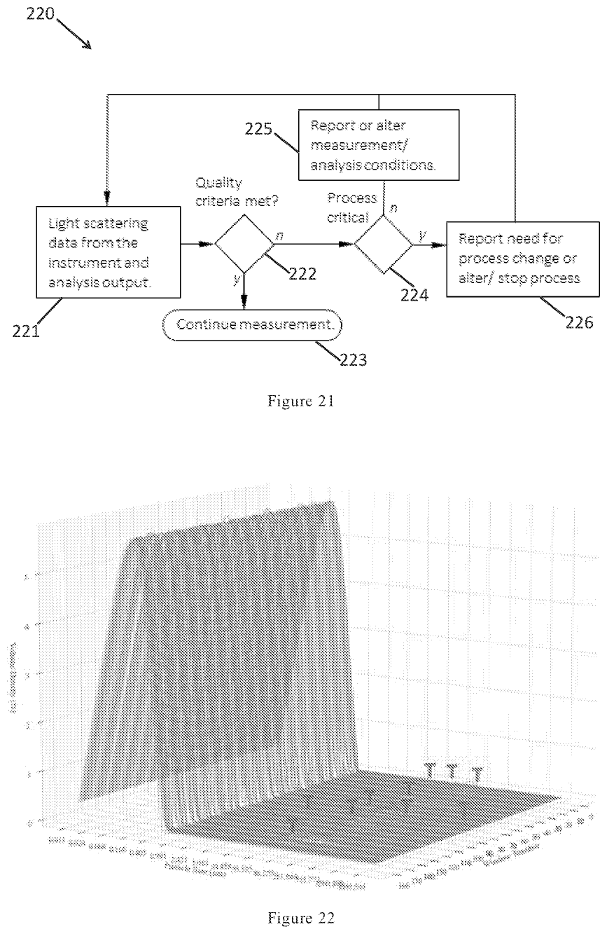

FIG. 21 demonstrates a method 220 which can be used to identify whether it is appropriate to adjust process or measurement parameters, for example in a continuously monitored process (e.g. manufacturing of particulates).

At step 221 a sub-run measurement of scattered light is obtained. At step 222, it is determined if the current sub-run meets one or more quality criteria. If the quality criteria are met, a subsequent measurement is obtained at step 223. If the quality criteria are not met, it is determined if the measurement is process critical at step 224. If the measurement is determined to be process critical, the need for a process change is reported or the process being monitored is stopped at step 226. If the measurement is determined not to be process critical, the measurement conditions are reported or altered at step 225. The method then restarts with the next measurement of the time series of measurements, if it decided to obtain the next measurement.

A similar approach may be used to create an adaptive measurement approach, in which a quality measurement is determined from each sub-run and compared with a quality criterion. The comparison between the quality measurement and the quality criteria can be used to determine whether adjustment of the measurement parameters is appropriate. The quality measurement may be derived from a particle characteristic determined from the sub-run (e.g. an average particle size, polydispersity etc), or may be determined with reference to the scattering data before processing (e.g. based on a value of maximum intensity of scattered light). The adjustment of the measurement may be automatic, and may include changing a duration of a sub-run; selecting a different algorithm used to process a sub-run to determine a particle characteristic; changing one or more settings of an algorithm used to process a sub-run to determine a particle characteristic; changing a wavelength, intensity or a modulation of the light beam; changing a spectral range or a spectral sensitivity profile of a detector; changing a total number of sub-runs to be obtained; changing a flow rate, a stir rate or ultrasonication of the sample; adjusting an agitation amplitude or frequency of the sample; adjusting an air-flow to the sample; adjusting a temperature of the sample; and adjusting degassing of the sample, a pH of the sample, a concentration of the sample, or a level of an additive and/or admixture in the sample.

Referring now to FIG. 22, a schematic multi-dimensional pictogram representation of particle size distribution for a plurality of sub-runs of a laser diffraction measurement exemplifying transient and non-transient sub-runs is shown. For ease of schematic representation, only a selection of transient sub-runs are denoted ‘T’, whilst non-transient sub-runs have been left un-labelled. In this figure, the ‘window number’ axis will be understood to represent time, with each line on the pictogram representing a sub-run (i.e. at a given time). Such a representation may provide a more holistic representation of the data than, for example, the summed transient and summed non-transient (i.e. time averaged) data shown in FIG. 10. For example, many of the real sample effects demonstrated as being identifiable from the non-transient, transient and trending classes may also be visually identifiable using this type of plot. This may prove beneficial if the instrument has, for example, a live display showing measurement results during said measurement (e.g. for monitoring and/or quality control processes). It may also assist with the clear and concise communication of the method, particularly applicable to traditionally and/or necessarily conservative markets such as quality assurance.

FIG. 23 also shows an alternative way to represent the resulting data, this time in the form of a schematic heat-map representation of particle size distribution for a plurality of sub-runs of a laser diffraction measurement exemplifying transient and non-transient sub-runs. In this figure, the transient particle fractions of a sub-run can be seen on the right as lines (some of which are identified with arrows), whereas the non-transient particle fractions of a sub-run are shown on the left (and denoted as ‘Steady State’ in the Figure).

Whilst not shown in FIG. 22 or 23, it should be appreciated that automated, semi-automated or manual initiation of the measurement, applied to coincide with a change in the instrument, sample environment, composition and/or chemistry of the dispersion, for example, could be clearly represented by marking the initiation point, or other time-resolved events of interest, on the plots, further simplifying their interpretation.

Advantageously, the techniques disclosed herein can allow the detection of single particle events during measurement. For example, single particle events are detectable in dry or wet dispersion measurements. This may enable the characterisation of ultra-low quantities of particulate samples when compared to known/currently marketed laser diffraction instruments. It should be noted that even though, by definition, a single particle must be mono-sized, analytical broadening of the detected event occurs due to the applied mathematical reduction being optimised for the more typical/common characterisation of multi-particle samples, resulting in a non-zero particle size distribution width in the reported measurement.

FIG. 24A shows measurement data for a multi-particle sample, with FIG. 24B (a reconstruction of data from a single particle, from the boxed area ‘B’ in FIGS. 24A) and 24C (a reconstruction of data from the boxed area ‘C’ in FIG. 24A) being a sub-set of the FIG. 24A results.

Utilising information, such as that disclosed herein, system controls may be optimisable to adjust and retain the sample concentration as a single particle, or limit the sample to a small number of particles (i.e., where the measurement is predominantly transient and individual particle scattering events may be detected). Such optimisation may include, but is not limited to, the pump and or stirrer speed of a stirred reactor wet sample presentation device, the flowrate from a syringe driver, the feed-rate from a dry powder free-fall feeder, or the feed-rate, hopper output gate-width and air-flow pressure or air flow-rate from a dry powder feeding accessory. Additionally, optimisation via manual titration or via a feedback loop from the measurement and/or any combination of these, such as semi-automated manual titration, for example, are all envisaged.

Referring again to FIG. 24A, and specifically the boxed region ‘A’, transient sub-runs/events may also be present along with the scattering from multi-particles that may be considered steady state particles in the beam at the same time. In each instance, i.e. sub-runs containing only transient events as well sub-runs containing both transient events and non-transient (e.g. steady-state) events, detection of a transient event may trigger the capture of a spatial domain image of the event or a video around the event. For example, the event may trigger a camera. However, the residence time of the particles in the beam will likely be of the order of microseconds, meaning image capture in this embodiment may be difficult. There are, however, cases where wet-dispersed samples may transit the beam much more slowly, particularly for bubble analysis or where dispersed particles of any kind require significant surfactant concentration to remain stable in dispersion, in such cases a syringe driver, wet-to-waste sample presentation scheme may run slowly enough, to avoid cavitation or foaming, that implementation of a camera on and capture image trigger may be possible.

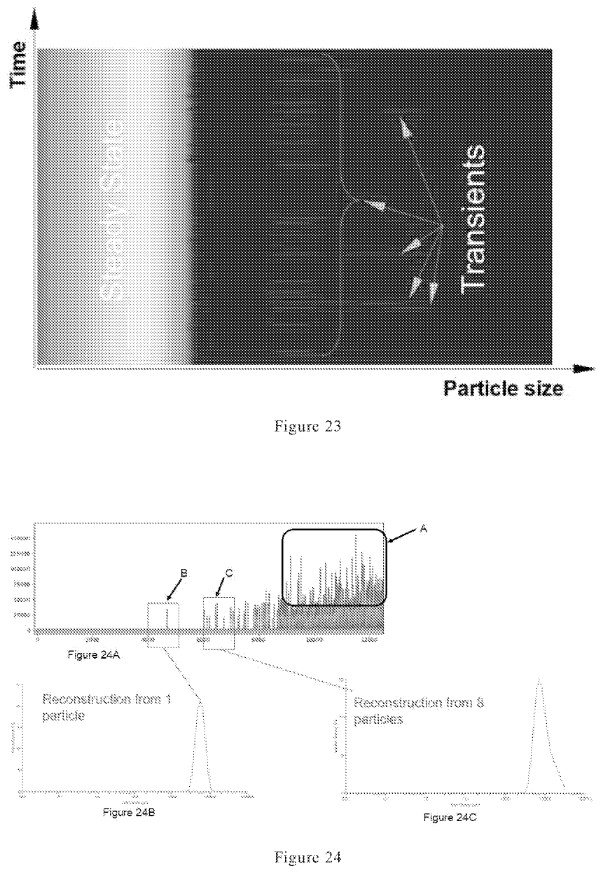

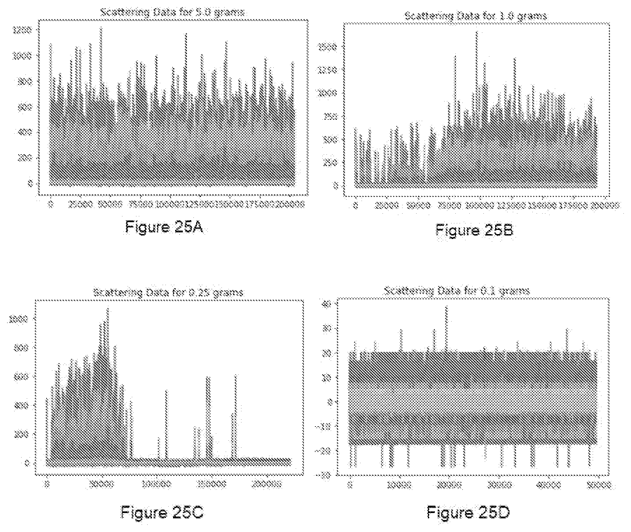

Referring now to FIGS. 25A-25D, the scattering data for a series of aliquot concentration reductions (5.0 grams, 1.0 grams, 0.25 grams and 0.1 grams, respectively) is shown. As the aliquot concentration is reduced (by reducing the mass of each aliquot for the same total volume of dispersant), the transition from multi-particle sample to single particle (or quasi-single particle) sample can be seen.

According to one embodiment, a camera may be continuously active, with a short running buffer of video stored to memory. This can assist in providing a significantly less stringent requirement on the time taken for the camera to turn on, at the detection of the event identified from the measurement, as each detected event could then easily be associated with an image frame of the event at the time (in the past) from the short video buffer. Additionally, the problem of capturing transient events in potentially supersonic particle velocity streams is solved, whilst also capturing the multi-particle sample characterisation using the non-transient mode. One particular benefit of this approach becomes apparent when considering that a typical aliquot for laser diffraction analysis may contain between 10¹⁰ to 10²⁰ particles. Avoiding multiple scattering, so that the recording of the images of the whole sample is simply not viable. Whereas the disclosed technique can allow the capture of images of all the transient objects in the dispersion.

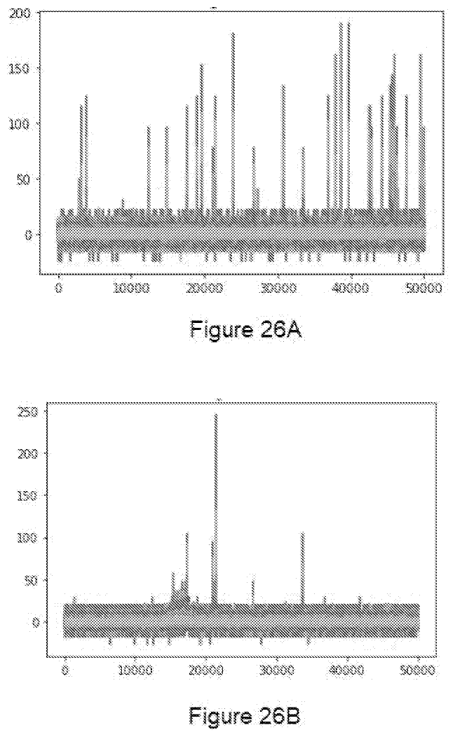

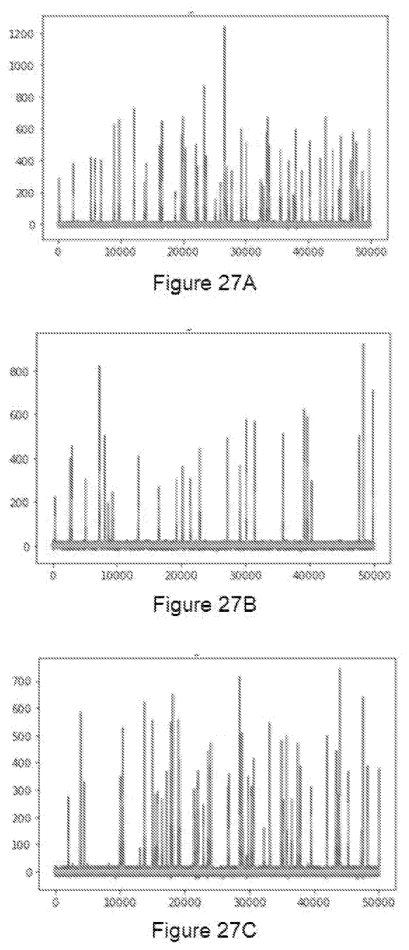

Referring now to FIGS. 26 and 27, exemplary scattering data for low sample quantities, including the resolution of single particles is shown. As observable by the fewer number of peaks in FIGS. 26A and 26B, the samples in those figures have a very low sample quantity compared to the low sample quantity of the samples in FIGS. 27A-27C.

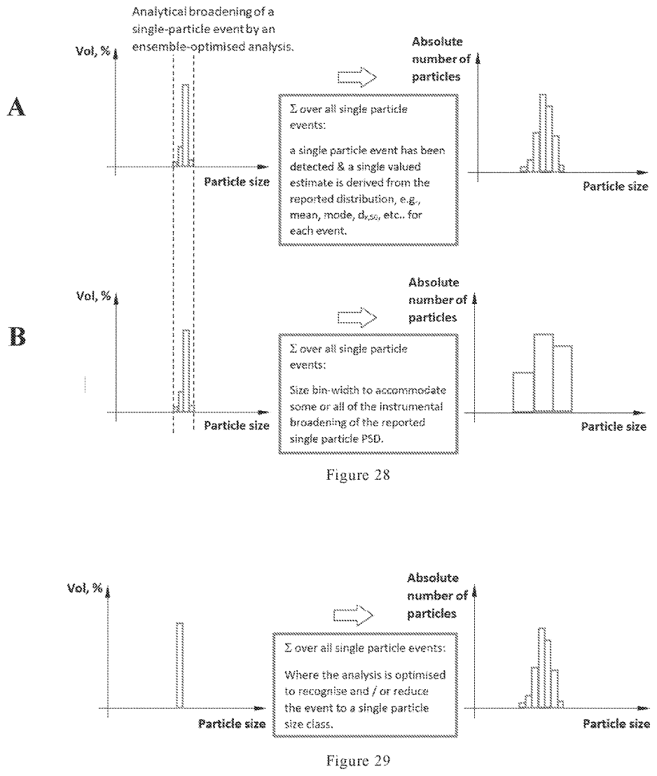

As already noted above, by definition, a single particle must be mono-sized. However, as shown in FIG. 28A, analytical broadening of the detected single-particle event occurs due to the applied mathematical reduction being optimised for the more typical/common characterisation of multi-particle (ensemble) samples, resulting in a non-zero particle size distribution width in the reported measurement. In FIG. 28A, the single particle event is detected, and a single valued estimate can be derived from the reported distribution (e.g. mean, mode, dx50, etc.) for each event. FIG. 28B, on the other hand, shows the particle size bin width (i.e. width of the column/range of particle size covered by each ‘bin’) being modified to accommodate some or all of the instrumental broadening of the reported single particle PSD (particle size distribution).

In this regard, the single particles may be identified/classified as a transient sub-run, and then subsequently used for further analysis.

FIG. 29 shows a further embodiment of the present disclosure, whereby the analysis has been optimised to identify single-particle events, and/or reduce the event to a single particle size class. With the analysis being optimised to identify single particle events (i.e. as a transient sub-run), it may also be possible to switch between analysis modes for different sub-runs. For example, a ‘traditional’ analysis may be applied to ‘non-transient’ sub-runs (e.g. multi-particle (ensemble) samples), whereas an ‘optimised’ analysis may be applied to ‘transient’ sub-runs (e.g. single-particle events). As will be appreciated by those skilled in the art, this switching between analysis modes may occur during measurements, responsive to the sample being measured.

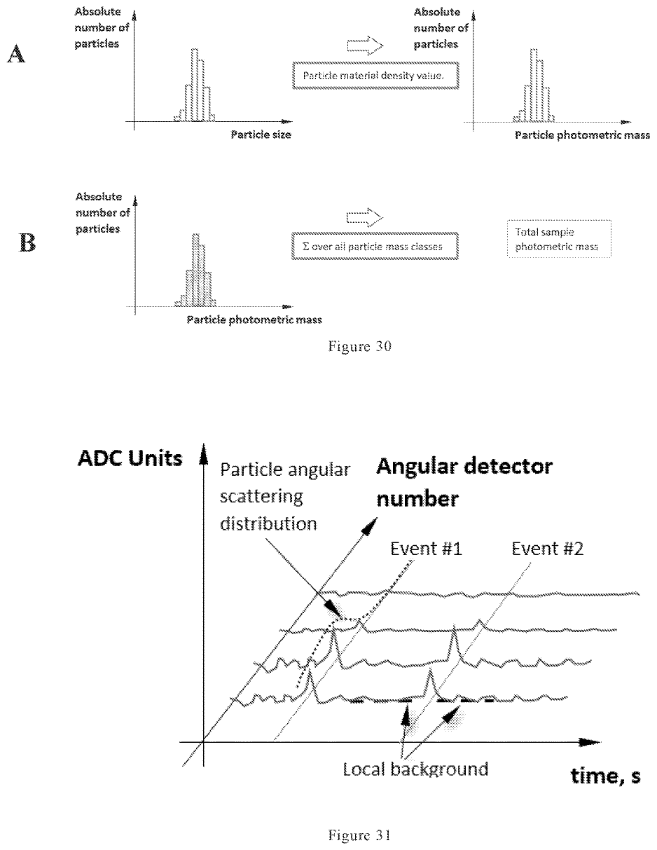

Single particle laser diffraction can enable a number of processing and sample property calculations that were not previously possible. For example, FIGS. 30A and 30B exemplify how, by estimating the absolute particle number-size distribution, this estimate can be converted to an associated particle mass-number distribution and, therefore, a sample total mass estimate can be obtained.

Additionally, since this technique provides a significantly more accurate measurement of the sample concentration than ‘bulk’ characterisation methods, such as photometrically calibrated schemes, verification of the optical properties of the sample (e.g. using the Beer-Lambert law combined with the Mie scattering calculation) is also significantly improved. In this regard, for an unknown multi-particle sample, an ultra-low concentration measurement that creates single particle data can be used to yield a highly accurate particle concentration value, which can then be used to verify or correct the complex refractive index, prior to characterisation of the multi-particle sample by the combination of Mie scattering theory and the Beer-Lambert law.

Since individual/single particles are detectable, a local background estimate may be derived from the dispersant-only scattering, as shown FIG. 31, around each particle event. A traditional laser diffraction measurement would ordinarily measure the background prior to adding the dispersed phase. However, as the instrument alignment and/or dispersant characteristics may drift over time, this prevents long time scale characterisation. Whereas embodiments of the present disclosure allow an estimate of the local background around each event, and therefore enable long time scale characterisation using laser diffraction.

In other embodiments the background estimate from a region (in time) of single scattering events may be used as an estimate of the background for regions (in time) of scattering measurements from multi-particle samples. In this way a multi-particle sample that intrinsically comprises fractions that present as single particle events and/or where such a particle fraction is deliberately added to the target multi-particle sample fractions, the background may be estimated in a continuous fashion for extended periods. In embodiments, an initial background may be recorded as per a ‘traditional’ measurement and the single particle background estimate may be used to infer when the pre-recorded background is no longer an accurate estimate of the background at a later time, during subsequent dispersed phase measurements. This can also assist in monitoring for changes/alterations in the background to identify when measurements should be stopped.

Yet another embodiment of interest may be in relation to sample titration. For example, when titrating a sample, changes in the sample characteristics with respect to deliberate changes in the dispersant, or changes responsive to the inclusion of an admixture to the dispersed phase, and where the admixture may interact with the primary particle size fraction surface, may be monitored. Specific, but not limiting, examples of this are PEGylation and/or Ostwald ripening. In these cases, monitoring the background in a ‘live’, or ‘real-time’ sense is critical, particularly when the chemistry of the dispersant is altered, thereby altering the background as the dispersant is titrated. In such a case, counting discrete particle scattering events would not necessarily be of interest, so a re-circulating dispersion system could be used to titrate the dispersion, with the background continuously being monitored throughout, but where each individual particle could be detected multiple times. In such a case a relative number population for each titrated result may be presented to the user (via the known technique of a Mie scattering conversion to number from the volume intensity-based measurement).

Once the background from each scattering event has been removed, and for a sufficiently high difference in optical contrast, a polyspectral Mie scattering ellipsometry, single particle measurement allows the detection and accurate characterisation of particles of the same size but different mass.

It has also been identified that the simultaneous collection of the properties of electromagnetic radiation scattered into multiple detection angles plays an integral part in a number of measurement types for materials characterisation that are closely related to both laser and x-ray diffraction. For example, the intensity as a function of angle is not the only property of the scattered (or unscattered) light that may be of interest. In this regard, the characterisation of the properties of electromagnetic radiation, emanating from a test sample into multiple angles, with the radiation at all angles being detected simultaneously, for, but not limited to, Mie scattering ellipsometry, diffractive spectroscopy, small angle neutron scattering, and the combination of diffraction, spectroscopy and imaging is also envisaged and disclosed herein. This may include, but is not limited to, physical quantities (in addition to intensity) such as discrete multiple wavelengths or over a wavelength range, polarisation-states and the quantities that are derived from it such as D, tan(j) and thereafter complex refractive index and data concerning the internal and external shaper of dispersed particles, as part of a Mie scattering ellipsometry measurement, for example, and phase shifts within each angle, differences in phase or phase-shift between angles and/or the absolute phase-difference of each detection angle with respect to a reference light path.

For Mie scattering ellipsometry, in particular, it is understood from the literature and commercially available solutions at the time of writing, that no solution currently exists that is able to create precise and accurate estimates of the particle refractive index from samples that are polydisperse and/or multimoded in particle size, particle shape or particle refractive index. Mie scattering ellipsometry measurements can be used to record all Jones or Stokes vector quantities simultaneously or sequentially in time, with embodiments of the present disclosure being equally applicable. For example, transient and steady state classes may be derived from the ellipsometric data for any or all scattering angles of interest. For example, the angular scattering pattern for an arbitrary sample may be characterised by minima and maxima in light intensity, an overall very low scattering intensity from an ensemble of particles of low scattering cross-section and/or for scattering from single particles. For high scattering single-particle samples traditional detector types, CMOS, etc., may still be used. However, for very low scattering cross section single particles newly available EMCCD, single photon sensitive or single photon counting detectors may be used to retrieve a signal to noise in the measurement appropriate to challenging applications such as aqueous bio-particle dispersions, detecting the difference in refractive index between filled and unfilled nano-and micro-particle based pharmaceuticals, such as mRNA filled lipids or adeno-associated viruses, for example. In single-photon sensitive cases, the recorded signal is a series of photon time arrival events, rather than an analogue intensity level, nonetheless aspects of embodiments disclosed herein may be applied to individual photon time-tagged data.

Although specific examples have been described, the scope of the invention should be determined with reference to the accompanying claims.

1. A method of investigating time varying sample characteristics, comprising:
illuminating a sample comprising particles with a light beam, so as to produce scattered light by the interaction of the light beam with the sample;
obtaining a measurement of the scattered light over a measurement period that is divided into a plurality of shorter sub-runs;
classifying each sub-run; and
determining the sample particle characteristic for the sub-runs,

2. The method of claim 1, further comprising transforming each sub-run prior to classifying each sub-run.

3. The method of claim 1, wherein determining the sample particle characteristic for the sub-runs occurs prior to classifying each sub-run.

4. The method of claim 1, further comprising determining a variation in the sample particle characteristic over time for the sub-runs.

5. The method of claim 1, wherein the sample characteristic comprises particle size and/or particle concentration.

6. The method of claim 5, further comprising determining a particle size distribution and identifying particle fractions for each sub-run in the classification, wherein the particle size is an average particle size for a particle fraction and/or the particle concentration is a concentration of the particle fraction.

7. The method of claim 1, wherein classifying each sub-run comprises determining a classification sample characteristic and comparing the classification sample characteristic with a threshold value of the same characteristic, wherein the threshold value is determined from the statistics of the classification sample characteristic in at least some of the sub-runs.

8. The method of claim 1, wherein classifying each sub-run comprises applying one or more classification rules selected from:
a) a classification sample characteristic being outside control limits, wherein the control limits are least 2.5 standard deviations from the mean;
b) a run of consecutive sub-runs of more than m particle classification characteristics to the same side of the mean;
c) a run of consecutive sub-runs of n particle classification characteristics all increasing or decreasing;
d) a run of consecutive sub-runs of o particle classification characteristics alternating up and down;
e) a run of consecutive sub-runs of p particle classification characteristics more than 2 standard deviations from the mean;
f) a run of consecutive sub-runs of q particle classification characteristics more than 1 standard deviation from the mean; and
a run of consecutive sub-runs of r particle classification characteristics within less than one standard deviation of the mean.

9. The method of claim 1, wherein classifying each sub-run comprises classifying each sub-run as either transient or non-transient, and further comprising automatically classifying the variation in the dynamic particle characteristic as trending or steady state.

10. The method of claim 9, further comprising automatically correlating a trending state in a first particle fraction with a complementary trending state in a second particle fraction,

11. A non-transient, machine readable medium, comprising instructions for configuring an apparatus comprising a processor to perform the method of claim 1.

12. An apparatus for investigating time varying particle characteristics, comprising:
a light source, a sample holder, a detector and a processor; wherein
the sample holder is configured to receive a sample comprising particles;
the light source is operable to illuminate the sample holder with a light beam so as to produce scattered light by interactions of the light beam with the particles of the sample;
the detector is configured to detect the scattered light over a measurement period;
the processor is configured to:
divide the measurement period into a plurality of shorter sub-runs;
classify each sub-run; and
determine a sample particle characteristic for the sub-runs.

13. The apparatus of claim 12, wherein the apparatus is configured to perform a diffraction analysis, and the apparatus comprises a plurality of detectors arranged to detect light scattered at a plurality of different scattering angles to the light beam incident on the sample.

14. An apparatus configured to perform the method of claim 1.
